(19) United States
(12) Patent Application Publication
(10) Pub. No.: US 2008/0006964 A1
(43) Pub. Date: Jan. 10, 2008

(54) Method of producing dies for extrusion molding of honeycomb structure bodies

(75) Inventor: Hitoshi Kanmura, Mie-ken (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/819,213

(22) Filed: Jun. 26, 2007

(30) Foreign Application Priority Data
Jul. 6, 2006 (JP) 2006-187048

(51) Int. Cl. B29C 47/00

(52) U.S. Cl. 264/177.12

(57) ABSTRACT

Ceramic honeycomb structure bodies are produced by using a die composed of ceramic batch supplying holes through which a ceramic batch is supplied and slit grooves through which the ceramic batch is extruded and shaped in a honeycomb structure shape. In a method of producing such a die, hardening is performed onto at least a slit groove formation surface of a die member in order to form a hardening treated film on the slit groove formation surface of the die member. After the completion of the hardening process, plural slit grooves are formed in the slit groove formation surface of the die member. A hardness of the hardening treated film of the die member is not less than 1.5 times of a hardness of the die member.

### CROSS-REFERENCE TO RELATED APPLICATION

This application is related to and claims priority from Japanese Patent Application No. 2006-187048 filed on Jul. 6, 2006, the contents of which are hereby incorporated by reference.

### BACKGROUND OF THE INVENTION

1. Field of the Invention

The present invention relates to a method of producing dies for use of performing extrusion molding for extruding honeycomb structure bodies in a lattice (or honeycomb) structure.

2. Description of the Related Art

Honeycomb structure bodies made of ceramic are used as exhaust gas purifying filter for purifying particulate matters (PM) in an exhaust gas emitted form an internal combustion engine such as a diesel engine of a vehicle. Such honeycomb structure bodies are produced by extruding ceramic batch of ceramic raw material through a honeycomb structure body extruding die (hereinafter, referred to as “die” in short).

One of various types of dies is composed of a die member in which batch supplying holes and slit grooves are formed. Ceramic batch of ceramic raw material is supplied through the batch supplying holes. The slit grooves are formed in a lattice (or honeycomb) structure and join to the batch supplying holes. Through the slit grooves, the ceramic batch of ceramic raw material is shaped into a honeycomb structure body in a lattice shape or a honeycomb structure shape. The repetition use of the die during the extrusion molding causes abrasion of the die because of contacting the ceramic batch to the die many times, and therefore raises its deterioration and of decreasing its dimensional accuracy.

In order to solve such a problem of the related-art techniques, Japanese patent laid open publication No. JP H5-269719 has proposed a method of coating the entire surface of a die having a plurality of batch supplying holes and slit grooves with abrasion proof material by using chemical vapor deposition (CVD) manner so as to enhance the abrasion proof performance of the die. However, it is in general difficult to form a uniform abrasion proof material onto the surface of the batch supplying holes and slit grooves in the die which have a complicated configuration. The related art techniques hardly keep the abrasion proof performance of the die for a long period of time. There is therefore a possibility of decreasing the dimensional accuracy of honeycomb structure bodies produced by the die which is made by the conventional manner. For this reason, there is a strong demand for producing dies of superior durability and abrasion proof performance, for use of performing the extrusion molding for producing ceramic honeycomb bodies.

### SUMMARY OF THE INVENTION

It is an object of the present invention to provide a method of easily and certainly producing dies having superior durability and abrasion proof performance for use of performing the extrusion molding of extruding honeycomb structure bodies.

To achieve the above purpose, the present invention provides a method of producing dies for use of performing extrusion molding of honeycomb structure bodies. Each die has batch supply holes and slit grooves formed in a lattice shape. Those slit grooves are joined to the batch supply holes. The slit grooves are capable of shaping the ceramic batch to a honeycomb structure body of a honeycomb shape. The method has steps of preparing a die member, hardening at least a slit groove formation surface of the die member in order to form a hardening treated film on the slit groove formation surface, and forming slit grooves in the slit groove formation surface of the die member. A hardness of the hardening treated film is not less than 1.5 times of the hardness of the die member.

In the method of producing dies for use of producing honeycomb structure bodies, the slit grooves are formed in the slit groove formation surface of the die member after the completion of the hardening process performed for at least the slit groove formation surface.

On the contrary, in related art techniques, the hardening process is performed to the surface of a complicated shape in which the slit grooves have already been formed.

That is, according to the method of the present invention, the hardening process is performed to the slit groove formation surface of a simple shape before the completion of the slit groove formation process. It is thereby possible to easily perform the hardening process in order to enhance the durability and abrasion proof performance of the die. In addition, the method according to the present invention provides the hardening treated film of a uniform thickness formed on the slit groove formation surface of the die member.

Further, the hardening process performs the hardening to at least the slit groove formation surface in order to form the hardening treated film thereon. The slit groove formation surface of the die produced by the method becomes a surface in which the plural slit grooves are formed, through which ceramic batch of raw material is extruded during the manufacturing honeycomb structure bodies. That is, the slit groove formation surface is the important surface to strongly influence the quality in shape of and the dimensional accuracy of the honeycomb structure bodies to be manufactured, because the slit groove formation surface is contacted with the ceramic batch of raw material many times in the manufacturing of the ceramic honeycomb structure bodies and causes excessive wear.

The method according to the present invention performs the hardening to the slit groove formation surface in order to make the hardening treated surface of a uniform thickness on the slit groove formation surface. Such a process sequence in the method according to the present invention can provide the dies having the superior durability and abrasion proof performance. It is also possible to keep the quality in shape of and the dimensional accuracy of the honeycomb structure bodies produced by using the die which is produced by the method according to the present invention.

In particular, the hardness of the hardening treated film is not less than 1.5 times of the hardness of the die member. The presence of the hardening treated film can enhance the durability and abrasion proof performance of the die produced.

According to the method of producing the dies, it is possible to easily and certainly produce the dies of superior durability and abrasion proof performance.

By the way, the hardness of the hardening treated film which is less than 1.5 times of the hardness of the die member causes a possibility of not providing the durability and abrasion proof performance of the die with adequate efficiency.

It is possible to perform slicing process manner in the slit groove formation process of forming the slit grooves. Such a slicing process manner using a thin cutter with diamond particles processes the slit groove formation surface in the die member.

It is further possible to use, as the die member, one of metals such as SKH (high speed steel), SKD (alloy tool steel), Stainless, Aluminum alloy, Titanium, Inconel®, HASTELLOY®, Stellite, Cemented carbide alloy, cermet, and related materials. The use of such a metal can easily and certainly form the hardening treated film on the die member.

It is preferred to perform the hardening process by one of PVD, CVD, DLC, electroplating, and electroless plating. Those manners can form the hardening treated film with high accuracy, and enable the die to certainly enhance its durability and abrasion proof performance. The present invention is not limited by using those manners, for example, it is possible to combine both the PVD and CVD processes, and also possible to combine a plurality of the hardening processes.

In particular, the PVD process can provide the hardening treated film with superior high-accuracy when compared with other hardening processes. In addition, because the PVD process can form a thicker film, the PVD process can form the hardening treated film with high efficiency.

The use of CVD process can enhance the adhesive capability of the hardening treated film to the die member. It is therefore possible to enhance the durability of the hardening treated film of the die.

The use of DLC (diamond like carbon) process can produce a DLC film of an extreme hardness. It is thereby possible to enhance the durability of the hardening treated film by performing DLC process.

It is preferred the hardness of the die member is not less than Hv 500. Because it is difficult to adequately keep the hardness of the die member when it is less than Hv500, there is a possibility of causing deformation of the die member. Such a deformation causes damage and separation of the hardening treated film from the die member. Hv500 or more corresponds approximately not less than 40 HRC.

It is therefore preferred that the hardness of the die member is within a range of Hv 500 to 760.

This case can adequately keep the hardness of the die member. It is thereby possible to suppress deformation of the die member and to form the batch supply holes and the slit grooves without causing any trouble. The hardness within a range of Hv500 to 760 corresponds approximately a range of 40 to 70 HRC.

It is preferred that the hardness of the hardening treated film is not less than Hv750.

Because the hardness of the hardening treated film of less than Hv750 does not adequately keep the hardness of the hardening treated film, there is a possibility of not increasing the durability and abrasion proof performance of the die.

It is therefore preferred that the hardness of the hardening treated film is not less than Hv1500. This case can adequately keep the hardness of the hardening treated film and further enhance the durability and abrasion proof performance of the die.

It is preferred that the thickness of the hardening treated film is not more than 1/10 times of a depth of each slit groove. When the thickness of the hardening treated film exceeds 1/10 times of a depth of each slit groove, because the pressure while extruding the ceramic batch of the raw material becomes high, there is a possibility of decreasing the formation speed and of breaking the die.

It is preferred that the thickness of the hardening treated film is not more than 0.5 mm. When the thickness of the hardening treated film is more than 0.5 mm (exceeds 0.5 mm), there is a possibility of decreasing the accuracy of forming the hardening treated film, and a possibility of decreasing the variation of the thickness of the honeycomb structure bodies produced by using the die. There is further a possibility of abnormally growing catalysts of the hardening treated film. This causes the separation of the hardening treated film from the die member.

### BRIEF DESCRIPTION OF THE DRAWINGS

A preferred, non-limiting embodiment of the present invention will be described by way of example with reference to the accompanying drawings, in which:

FIG. 1 is a perspective view of a die member to be processed by the method according to a first embodiment of the present invention;

FIG. 2 is a sectional view showing the die member placed on a CVD jig for use of performing CVD process in the method according to the first embodiment;

FIG. 3 is a sectional view showing a configuration of the CVD apparatus to be used in the method according to the first embodiment;

FIG. 4 is a perspective view of the die member after hardening process in the method according to the first embodiment;

FIG. 5 is a plane view of the die member, produced by the method of the embodiments, for use of performing extrusion molding for extruding and shaping honeycomb structure bodies;

FIG. 6 is a sectional view of the die shown in FIG. 5;

FIG. 7 is an enlarged sectional view of a slit groove formed in a slit groove formation surface of the die member in the method according to the first embodiment;

FIG. 8 is a graph showing a relationship between distance L and thickness S of a hardening treated film in each die produced by the method according to the first embodiment;

FIG. 9 is a view showing the die member fixed to the CVD jig in the method according to the first embodiment;

FIG. 10 is a view showing a die member fixed to a PVD jig in a method according to a second embodiment of the present invention;

FIG. 11 is a sectional view of a configuration of a PVD apparatus to be used in the method according to the second embodiment;

FIG. 12 is a graph showing a relationship between distance L and thickness S in each die produced by the method according to the second embodiment;

FIG. 13 is a view showing the die member fixed to the PVD jig in the method according to the second embodiment of the present invention;

FIG. 14 is an enlarged sectional view of a slit groove formed in a slit groove formation surface of a die produced by the method according to a third embodiment of the present invention;

FIG. 15 is a graph showing a relationship between distance L and thickness S in each die produced by the method according to the third embodiment of the present invention; and

FIG. 16 shows an evaluation result of samples (dies) in useful life (or durability) as a fourth embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

A description will now be given of a method of producing dies for use of extruding ceramic batch in order to produce honeycomb structure bodies according to a first embodiment of the present invention.

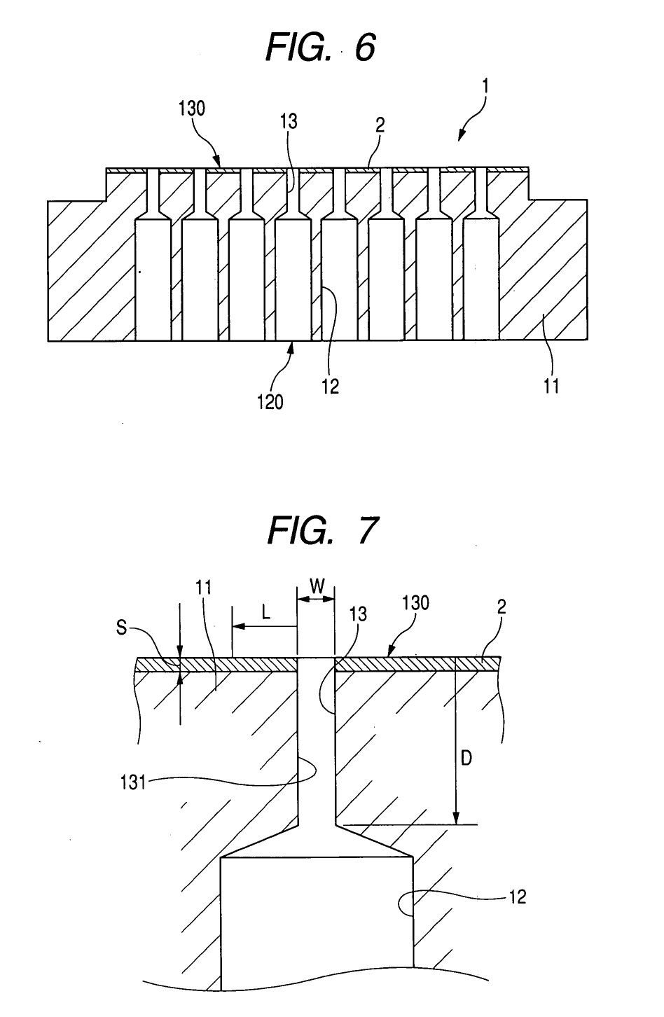

The honeycomb structure body shaping die 1 (hereinafter, referred to as “the die 1” in short) shown in FIG. 5 and FIG. 6 is used in manufacturing of the honeycomb structure bodies by extruding ceramic batch of ceramic raw material. The die 1 has plural batch supplying holes 12 and plural slit grooves 13. The slit grooves are joined to the corresponding batch supply holes 12. Those slit grooves 13 are arranged in a lattice shape. The ceramic batch is shaped in a honeycomb structure through the plural slit grooves of the die 1.

In the method of producing the die 1 according to the first embodiment of the present invention, a slit groove formation process of making the slit grooves 13 is performed after the completion of a hardening process which forms a hardening treated film 2 on a slit groove formation surface 130 of the die member 11. The hardness of the hardening treated film 2 is not less than 1.5 times of that of the die member 11.

A description will now be given of the hardening process and the slit groove formation process in the method according to the first embodiment.

### <Preparation Step>

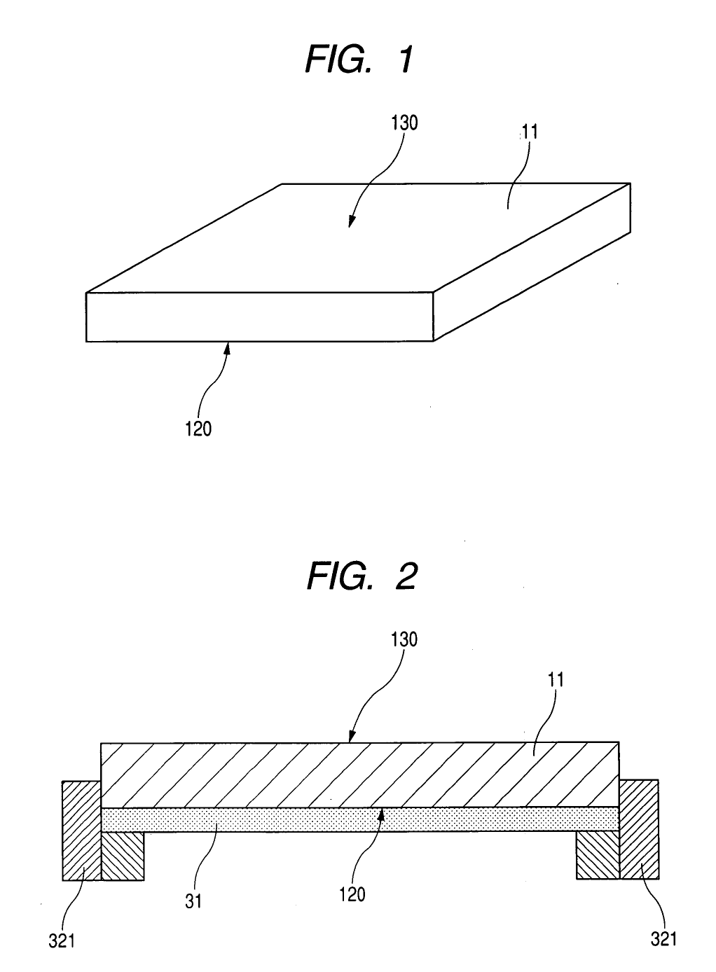

FIG. 1 is a perspective view of the die member 11 to be processed by the method according to the first embodiment of the present invention. As shown in FIG. 1, the die member 11 as the material of the die 1 is prepared at first. The die member 11 has the batch supplying hole formation surface 120 and the slit groove formation surface 130. In the batch supplying hole formation surface 120, the batch supplying holes 12 are formed. In the slit groove formation surface 130, the slit grooves 13 are formed. In a concrete example, a metal plate of 200 mm×200 mm×20 mm and Hardness Hv 500 made of SKD (as alloy tool steel) was used.

### <Hardening Process>

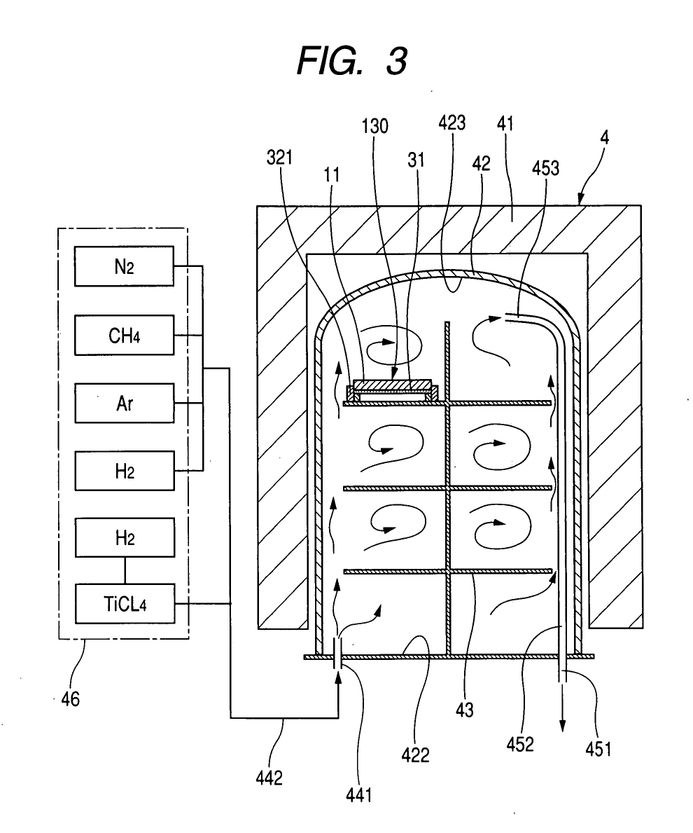

FIG. 2 is a sectional view showing the die member 11 placed on a CVD jig for use of performing CVD process in the method according to the first embodiment. FIG. 3 is a sectional view of a configuration of the CVD apparatus to be used in the method according to the first embodiment.

As shown in FIG. 2 and FIG. 3, the hardening process is performed for the slit groove formation surface 130 of the die member 11 in order to make the hardening treated film 2. In the first embodiment, a CVD apparatus 4 performs the CVD process as the hardening process.

A description will now be given of the hardening process performed by the CVD apparatus in detail.

As shown in FIG. 3, the CVD apparatus 4 is equipped with a reaction furnace 41 of a cylindrical shape whose bottom is open. The reaction furnace 41 has a diameter 450 mm and a height 700 mm. A reactor 42 is placed in the reaction furnace 41. The reactor 42 has a plurality of divided rooms. Each divided room has plural pedestals 43. On each pedestal 43 the die member 11 is placed during CVD process.

A gas supply inlet 441 is formed at a bottom part 422 of the reaction furnace 42. Through the gas supply inlet 441 and gas supply pipes 442, reaction gases are introduced from a gas supply apparatus 46 into the reaction furnace 42. The gas supply apparatus 46 is placed at the outside of the CVD apparatus 4. Thus, the CVD apparatus 4 has the configuration of introducing the reaction gases from the gas supply apparatus 46 into the reaction furnace 42. The method of the first embodiment uses TiCl₄, H₂, Ar, CH₄ and N₂ as the reaction gases.

As shown in FIG. 3, an exhaust gas outlet 451 is formed at the bottom part 422 of the reaction furnace 42. The exhaust gas outlet 451 is joined to an exhaust gas pipe 452 placed between the top part 423 of the reaction furnace 42 to the bottom part 422. The CVD apparatus 4 is equipped with an exhaust gas inlet 453 and the exhaust gas outlet 451. The residual reaction gases are exhausted in the reaction furnace 42 to the outside through the exhaust gas inlet 453 and the exhaust gas outlet 451.

In the hardening process, the CVD process is performed in the CVD apparatus 4. At first, masking is performed on the batch supplying hole formation surface 120 of the die member 11. In a concrete example, as shown in FIG. 2, the batch supply hole formation surface 120 is covered with a masking plate 31 made of graphite. The die member 11 and the masking plate 31 are tightly fastened and fixed together by a CVD jig 321. Following, the masking is performed on the batch supplying hole formation surface 120 of the die member 11.

Next, as shown in FIG. 3, the die member 11 fixed on the CVD jig 321 is placed on one of the pedestals 43 so that the reaction gases are easily contacted to the slit groove formation surface 130 of the die member 11 and the slit groove formation surface 130 is faced to a sealing part 423 of the reaction furnace 42. The reaction furnace 42 is heated at a temperature range of 900° C. to 1000° C. In this condition, the gas supply apparatus 46 supplies the reaction gases TiCl₄, H₂, Ar, CH₄ and N₂ to the inside of the reaction furnace 42.

As shown in FIG. 3, under the condition described above, chemical reaction takes place on the slit groove formation surface 130 of the die member 11 by contacting the reaction gases, which are circulated in the reaction furnace 42 during the CVD process, to the die member 11 heated at a high temperature. The chemical reaction produces a thin film made of TiC, TiCN and TiN formed on the slit groove formation surface 130.

The reaction furnace 42 is then cooled after the completion of the chemical reaction. The CVD jig 321 is taken out from the reaction furnace 42 and the die member 11 is released from the CVD jig 321.

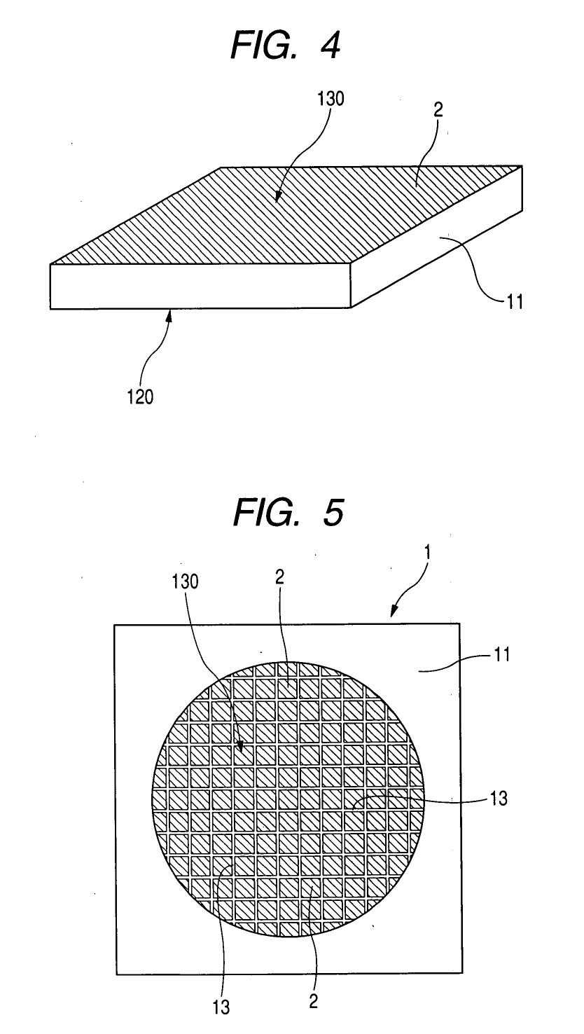

FIG. 4 is a perspective view of the die member after hardening process in the method according to the first embodiment. As shown in FIG. 4, the die member 11 having the slit groove formation surface 130 on which the hardening treated film 2 is formed is obtained by the processes described above. The hardening treated film 2 is a laminated film composed of three layers made of a TiC layer, a TiCN layer, and a TiN layer.

### <Batch Supplying Hole Formation Process>

FIG. 5 is a plane view of the die 1, produced by the method according to the first embodiment, for use of performing extrusion molding for extruding ceramic batch and forming honeycomb structure bodies. FIG. 6 is a sectional view of the die 1 shown in FIG. 5.

As shown in FIG. 6, the batch supplying hole formation process is performed in order to form the batch supply holes 12 of a specified depth in the batch supplying hole formation surface 120 of the die member 11. The method of the first embodiment uses a carbide drill in order to form the shape of the batch supply holes 12.

### <Slit Groove Formation Process>

Next, as shown in FIG. 5 and FIG. 6, the slit groove formation process is performed in order to form the plural slit grooves 13 in the slit groove formation surface 130 of the die member 11, where the slit grooves 13 are joined to the batch supply hones 12. In the method of the first embodiment, the slit grooves 13 of a rectangle shape in a lattice arrangement are formed in the slit groove formation surface 130 of a circular shape which is projected from the surrounding part of the die member 11 by a slicing manner (using thin film cutters with diamond particles and the like). Processing the part of the hardening treated film 2 is performed at a half of the speed of the cutter feeding for processing a part of the die member 11.

The honeycomb structure body shaping die 1 is produced by the above processes.

As shown in FIG. 5 and FIG. 6, the honeycomb structure body shaping die 1 has the batch supply holes 12 formed in the batch supplying hole formation surface 120 and the slit grooves 13 formed in the slit groove formation surface 130. The hardening treated film 2 is formed on the slit groove formation surface 130.

FIG. 7 is an enlarged sectional view showing the slit groove formation surface 130 of the die 1 to be used in the method according to the first embodiment. As shown in FIG. 7, the slit groove 13 has the depth “D” of 5 mm and the width ‘W’ of 140 mm. The hardness of the hardening treated film 2 is Hv2000, which is approximately four times of the die member 11. The thickness “S” of the hardening treated film 2 is 3 μm, which is not more than 1/10 of the depth “D” of the slit grooves 13.

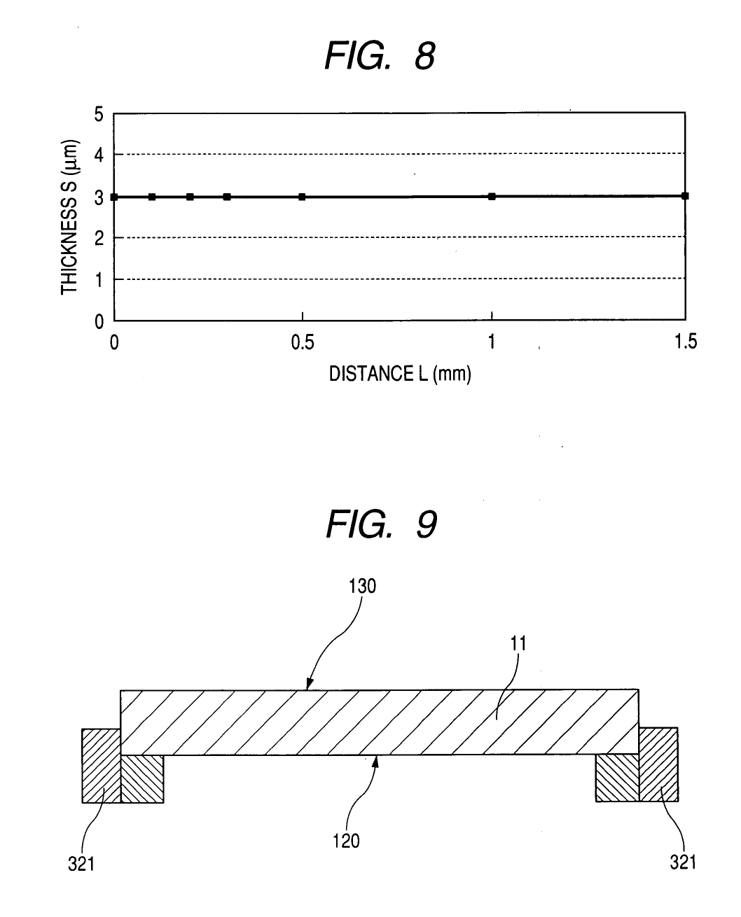

FIG. 8 is a graph showing a relationship between the distance L (mm) and the thickness S (mm) of the hardening treated film 2 in each die 1 produced by the method according to the first embodiment. As shown in FIG. 7, the distance “L” is a distance measured from the inner surface 131 of the slit groove 13 to a position on the surface of the hardening treated film 2. The thickness “S” is the hardening treated film 2 formed on the slit groove formation surface 130 in the die member 11.

As shown in FIG. 8, the hardening treated film 2 formed on the slit groove formation surface 130 has a uniform thickness 3 μm.

Next, a description will now be given of the action and effects of the method and the die produced by the method according to the first embodiment of the present invention. In the method of the first embodiment described above, the slit groove formation process of making the slit grooves 13 is performed after the hardening process. That is, before forming or processing the slit grooves 13, the hardening process is performed in order that the hardening treated film 2 is formed on the slit groove formation surface 130. Following, the slit grooves 13 are formed in the slit groove formation surface 130 of a flat shape which has been processed by the hardening process.

Therefore, in the method of producing the die according to the first embodiment, the hardening process is performed for the slit groove formation surface 130 of a plane shape before performing the slit groove formation process. Thereby, the method of the first embodiment can easily perform the hardening process with high accuracy in order to increase and enhance the durability and abrasion proof performance of the die 1 as the product. Further, the method of the first embodiment can uniformly form the hardening treated film 2 on the slit groove formation surface 130.

On the contrary, in related-art techniques, a hardening process is performed to the surface of a die member having a complicated shape in which slit grooves have already been formed.

In the method of the first embodiment, the hardening process is firstly performed for the slit groove formation surface 130, and the hardening treated film 2 is formed on the slit groove formation surface 130 of the die member 11.

On producing the honeycomb structure bodies, the slit groove formation surface 130 in the die 1 as the product of the method of the first embodiment is the surface having the plural slit grooves 13 through which the ceramic batch of ceramic raw material is extruded. In other words, the slit groove formation surface 130 is the important surface for keeping the high quality in shape of and the accuracy in dimension of the honeycomb structure bodies to be produced. In addition, the slit groove formation surface 130 is rapidly worn away since it has been used with ceramic batch so frequently. The method of the first embodiment performs the hardening process to the slit groove formation surface 130 and makes the hardening treated film 2 of a uniform thickness on the slit groove formation surface 130. This can efficiently increase and enhance the durability and abrasion proof performance of the die 1 as the product. The method of the first embodiment can keep the quality in shape of and the accuracy in dimension of the honeycomb structure body produced.

Further, the method of the first embodiment provides the hardening treated film 2 formed on the slit groove formation surface 130, where the hardness of the hardening treated film 2 is not less than 1.5 times of that of the die member 11. The formation of the hardening treated film 2 can improve the durability and abrasion proof performance of the die 1 produced.

The method of the first embodiment uses CVD process as the hardening process. Such a CVD process can enhance the degree of the adhesion of the hardening treated film 2 onto the slit groove formation surface 130. This can provide the superior durability of the hardening treated film 2 in the die 1.

Still further, because the hardness of the hardening treated film 2 is not less than Hv1500, it is thereby possible to adequately keep the hardness of the hardening treated film 2 and to further enhance the durability and abrasion proof performance of the die 1.

According to the method of the first embodiment described above, it is possible to easily perform the hardening process with high accuracy in order to enhance the durability and abrasion proof performance of the die 1 for use of extruding ceramic batch of raw material for producing honeycomb structure bodies. Still further, the use of the die 1 in the extrusion molding process can provide the honeycomb structure bodies having a superior durability and abrasion proof performance.

In the hardening process in the method of the first embodiment, as shown in FIG. 2, the CVD process is performed after the completion of the masking process with the masking plate 31 on the batch supplying hole formation surface 120 of the die member 11.

FIG. 9 is a view showing the die member 11 fixed to the CVD jig in the method according to the first embodiment. As shown in FIG. 9, it is possible to perform the CVD process without masking. In this case, the hardening treated film 2 is formed on both the batch supplying hole formation surface 120 and the slit groove formation surface 130 after the hardening process. The carbide drill is used at a feeding speed which is lower than the feeding speed for processing the die member 11 in order to process the plural batch supplying holes 12 without any trouble when the hardening treated film 2 formed on the batch supplying hole formation surface 120 is processed in the batch supplying hole formation process.

In addition, it is possible to process the plural batch supplying holes 12 after removing the hardening treated film 2 from the batch supplying hole formation surface 120 by performing surface grinding.

Although the plural batch supplying holes 12 are formed after the hardening process, it is acceptable to form the plural batch supplying holes 12 before performing the hardening process. That is, in the method of the first embodiment, it is possible to perform the hardening process and the slit groove formation process after the preparation process and the batch supplying holes formation process. In this case, like the manner of the first embodiment, it is possible to provide the die 1 having the superior durability and abrasion proof performance.

Further, although the hardening treated film 2 is formed on the batch supplying hole formation surface 120 having the plural batch supplying holes 12 when no masking is performed in the hardening process, it is possible to produce the die 1 with high quality in shape and with high dimensional accuracy, and with superior durability and abrasion proof performance.

### Second Embodiment

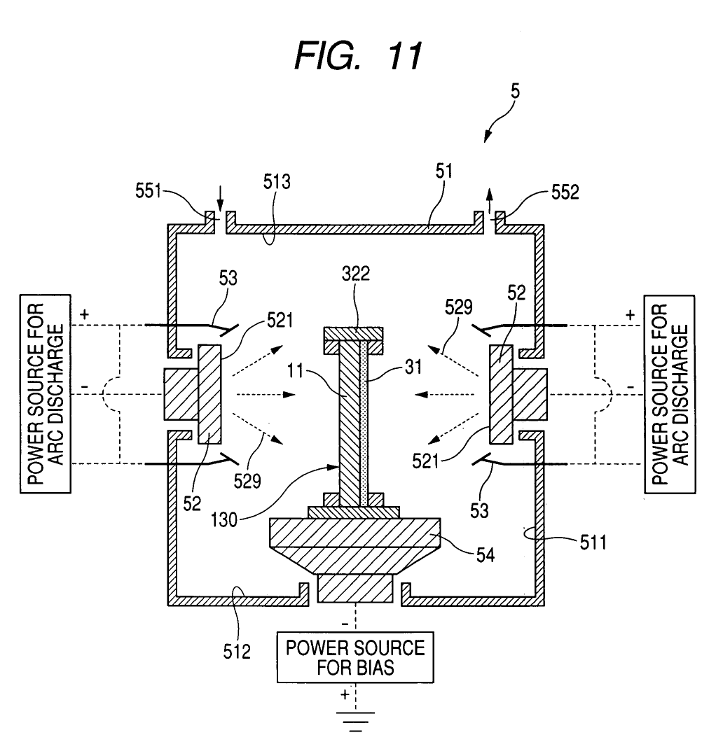

In the method of producing the die 1 for use of performing the extrusion molding of a ceramic batch for producing honeycomb structure bodies according to the second embodiment of the present invention, a physical vapor deposition (PVD) process is performed as the hardening process instead of the CVD process used in the first embodiment. In the following explanation of the method of the second embodiment, the PVD process is performed on the slit groove formation surface 130 of the die member 11. The PVD process is performed by a PVD apparatus 5 shown in FIG. 11.

A description will now be given of the PVD process as the hardening process in the method according to the second embodiment.

FIG. 11 is a sectional view of a configuration of the PVD apparatus 5 for use of performing the hardening process in the method according to the second embodiment.

As shown in FIG. 11, the PVD apparatus 5 has a reactor 51 of a cylindrical shape. Metal targets 52 (as negative pole) are placed at the inner surface 511 of the reactor 51. A pair of anode plates 53 (as positive pole) is placed at each metal target 52. The anodes plates 53 are electrically connected to a positive side (designated by character “+”) of the power source for arc discharge and the metal targets 52 are electrically connected to a negative side (designated by character “−” side) of the power source for arc discharge. In the second embodiment, the metal targets 52 are made of one of chromium (Cr) and Titanium (Ti).

As shown in FIG. 11, a turntable 54 is placed at the bottom side of the reactor 51, capable of rotating in a horizontal direction of the reactor 51. The turntable 54 is electrically connected to the power source for bias.

A gas supply inlet 551 and a gas exhaust outlet 552 are formed at a ceiling part 513 of the reactor 51. The reaction gases are introduced through into the reactor 51 from gas supply apparatus (not shown), and the residual reaction gases are exhausted to the outside of the reactor 51 through the gas exhaust outlet 552. A vacuum pump (not shown) is mounted on the reactor 51.

In the hardening process in the method according to the second embodiment, namely, as the PVD process performed by the PVD apparatus 5 of the above configuration, a masking is firstly performed on the batch supplying hole formation surface 120 in the die member 11.

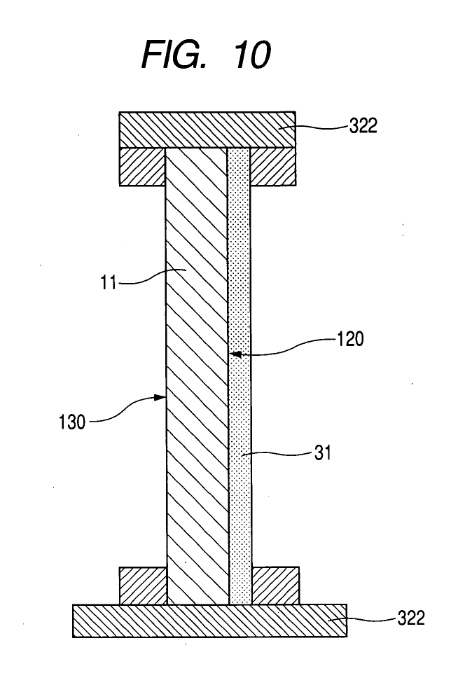

FIG. 10 is a view showing the die member 11 fixed to a PVD jig 322 used in the method according to the second embodiment. In a concrete example, as shown in FIG. 10, the batch supplying hole formation surface 120 is covered with a masking plate 31 made of graphite.

The die member 11 and the masking plate 31 are tightly fastened and fixed by the PVD jig 322. The masking is then performed on the batch supplying hole formation surface 120 of the die member 11.

Following, as shown in FIG. 11, the PVD jig 322 to which the die member 11 is fixed is placed on the turn table 54 so that the slit groove formation surface 130 of the die member 11 is faced to the metal target 52.

The reactor 51 is then vacuumed to 1×10⁻⁶ Torr by the vacuum pump (not shown) and heated at 500° C. under the pressure of 1×10⁻⁶ Torr. In this condition, the reaction gas N₂ is supplied into the reactor 51 through the gas supply inlet 551.

Next, as shown in FIG. 11, arc discharge is generated on and around the surface of each metal target 52 as the cathode (negative side). The material forming the metal targets 52 is vaporized in a moment and becomes metal ions 529 by the energy of arc current (approximately within a range of 70 A to 200 A) generated at the arc discharging. Those ions are flying in the reactor 51.

The speed of those ions is accelerated by applying the bias voltage from the bias power supply to the PVD jig 321 through the turn table 54.

Those flying ions and reaction gas particles (N₂) as film material (CrN and TiN used in the second embodiment) collide with the slit groove formation surface 130 of the die member 11 and are accumulated as a thin film on the slit groove formation surface 130. In the second embodiment, because the above process is performed while rotating the turn table 54, it is possible to form the thin film of a uniform thickness on the slit groove formation surface 130 of the die member 11.

Following, the reactor 51 is cooled to an atmosphere pressure condition. The PVD jig 322 is taken out from the reactor 51. The die member 11 is released from the PVD jig 322.

In the second embodiment, the PVD process is further performed again using the metal target 52 made of Titanium (Ti) after the PVD process using the metal target 52 made of chromium (Cr). It is thereby possible to obtain the die member 11 in which the hardening treated film 2 is formed on the slit groove formation surface 130. The hardening treated film 2 has a double layer configuration made of a CrN layer and a TiN layer.

Other processes in the method according to the second embodiment are the same as those in the method of the first embodiment. Therefore the explanation of those same processes is omitted here.

The die 1 for use of performing the extrusion molding for producing the honeycomb structure bodies is produced by the method described above.

The die 1 according to the second embodiment has the hardening treated film 2 formed on the slit groove formation surface 130, like the configuration (shown in FIG. 5 to FIG. 7) of the die produced by the method of the first embodiment.

The hardness of the hardening treated film 2 in the die 1 produced by the method of the second embodiment is Hv2000 which is approximately four times of that of the die member 11. The thickness “S” of the hardening treated film 2 is 1.8 μm, and the depth “D” of the hardening treated film 2 is 1/10 times of the depth (=5 mm) of the slit groove 13.

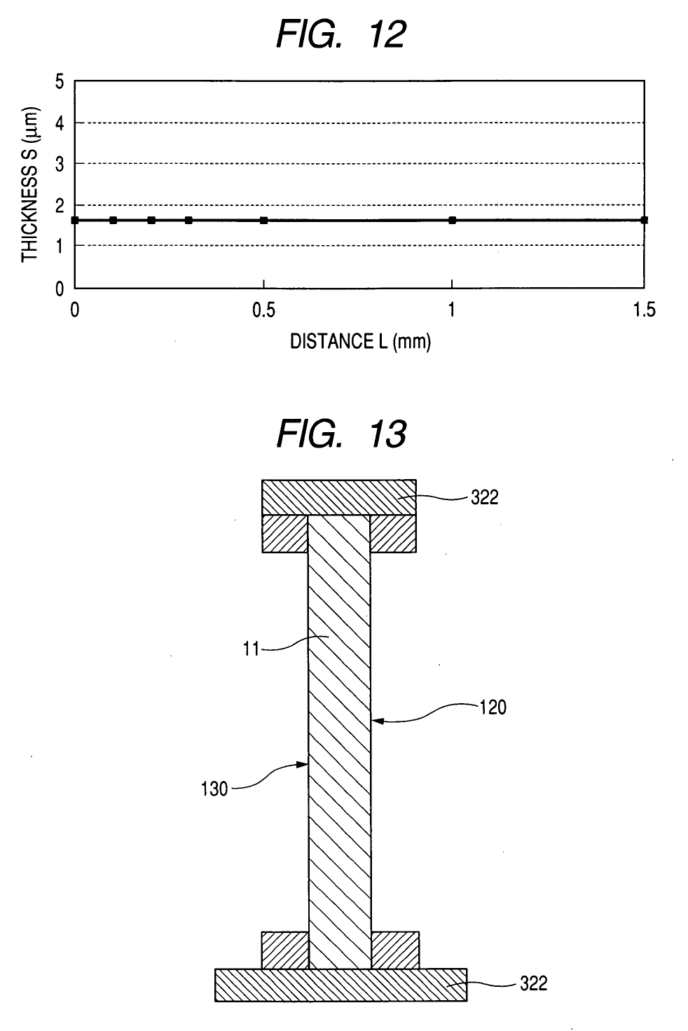

FIG. 12 is a graph showing a relationship between the distance L and the thickness S in each die produced by the method according to the second embodiment. In FIG. 12, the distance “L” and the thickness “S” are the same meaning explained in the experimental result shown in FIG. 8 according to the first embodiment.

As shown in FIG. 12, the hardening treated film 2 of a uniform thickness 1.8 μm is formed on the slit groove formation surface 130. Other configuration of the die produced by the method of the second embodiment is the same as those of the die produced by the method of the first embodiment.

The method of producing the die according to the second embodiment can produce the die of a superior durability and abrasion proof performance, like the method according to the second embodiment.

The method of the second embodiment performs the PVD process. In general, the PVD process produces a film with extremely high accuracy, and it is thereby possible to form the hardening treated film 2 with more high accuracy. Because the PVD process can provide a thick film, it is possible to efficiently form the hardening treated film 2.

The method of the second embodiment has other effects which are the same as those of the method according to the first embodiment.

In the method of the second embodiment, as shown in FIG. 10, the PVD process is performed after the completion of the masking process for the batch supplying hole formation surface 120 of the die member 11.

FIG. 13 is a view showing the die member fixed to the PVD jig to be used in the method according to the second embodiment of the present invention. However, it is possible to perform the PVD process without performing the masking process, as shown in FIG. 13. In this case, although the hardening treated film 2 is formed on both the surface of the batch supplying hole formation surface 120 and the surface of the slit groove formation surface 130, it is possible to process the plural batch supplying holes 12 without any troubles.

In the method of the second embodiment, the plural batch supplying holes 12 are formed after the hardening process. However, it is possible to form the plural batch supplying holes 12 in advance before performing the hardening process. That is, the method of the second embodiment can perform the sequence of the hardening process and the slit groove formation process after the preparing process and the batch supplying hole formation process in order.

### Third Embodiment

The method according to the third embodiment of producing the die 1 for use of performing the extrusion molding process of producing honeycomb structure bodies performs the hardening process by both the CVD process and the PVD process.

In the third embodiment, the CVD process is performed on the slit groove formation surface 130, and the PVD process is then processed on the slit groove formation surface 130. The CVD process is performed by the same sequence of the CVD process in the first embodiment, and the PVD process is performed by the same sequence of the PVD process in the second embodiment.

The remaining processes other than the CVD process and the PVD process are the same as those in the method of the second embodiment. Therefore the explanation of those same processes in the method of the third embodiment is omitted here.

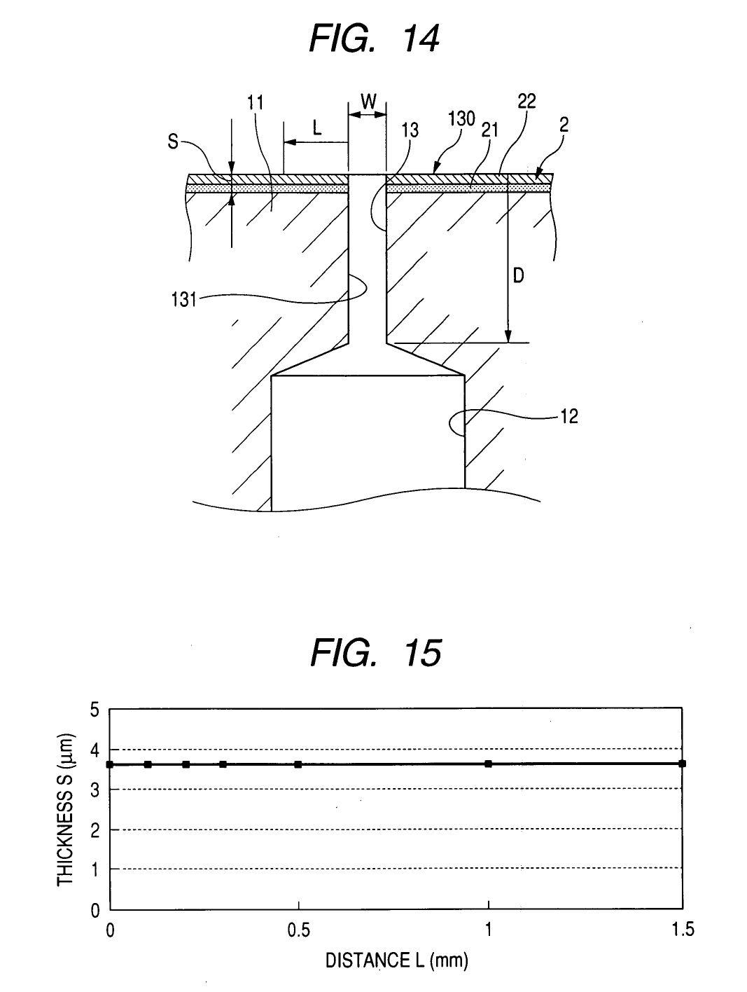

FIG. 14 is an enlarged sectional view showing the slit groove formation surface 130 of the die 1 produced by the method according to the third embodiment of the present invention.

The die 1 for use of performing the extrusion molding of the honeycomb structure bodies produced by the method of the second embodiment, as shown in FIG. 14, the hardening treated film 2 is formed on the slit groove formation surface 130 and the hardening treated film 2 has the two layer structure composed of a CVD film formed by the CVD process and a PVD film formed by the PVD process. The thickness “S” of the entire hardening treated film 2 in the die 1 produced by the method of the third embodiment is 3.6 μm, which is not more than 1/10 of the depth “D” (=5 mm) of the slit grooves 13.

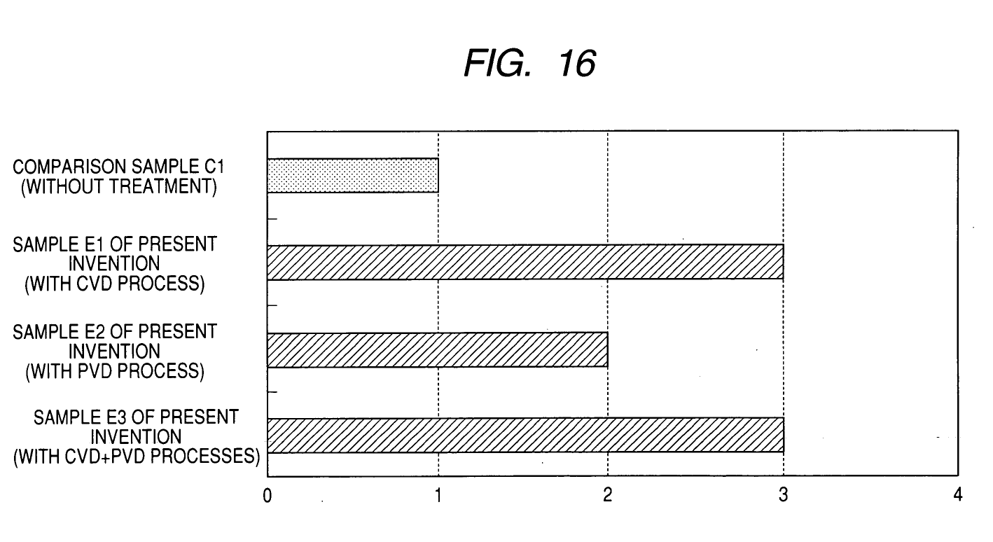

FIG. 15 is a graph showing a relationship between distance L (mm) and thickness S (μm) in the die produced by the method according to the third embodiment. As can be understood from FIG. 15, the hardening treated film 2 of a uniform thickness of 3.6 μm is formed on the slit groove formation surface 130.

The die produced by the method of the third embodiment has the action and effects which are the same of those of the die produced by the method of the first embodiment.

### Fourth Embodiment

The fourth embodiment provides the evaluation results of life of various types of the dies (Samples E1 to E3) produced by the first to third embodiments according to the present invention and the die (as comparison Sample C) produced by a conventional manner. That is, in the evaluation in life, plural honeycomb structure bodies were produced repeatedly by using the following samples:

Sample E1 (die) produced by the method according to the first embodiment using CVD process;

Sample E2 (die) produced by the method according to the second embodiment using PVD process;

Sample E3 (die) produced by the method according to the third embodiment using both CVD process and PVD process; and

Comparison sample C (comparison die) produced by a related art manner without CVD process and PVD process.

An initial width of the slit groove 13 in each sample (die) is 140 mm.

Next, a description will now be given of the evaluation manner of evaluating the samples E1 to E3 and the comparison sample C.

Ceramic batch including cordierite ceramic raw material was extruded through the samples E1 to E3 (samples E1 to E3). Each honeycomb structure body produced by the samples has a cylindrical shape whose diameter is 100.0 mm and whose length is 90.0 mm. The production of each types of the honeycomb structure body was repeated until the useful life of the die, namely, until the width of the slit groove 13 reaches 150 μm or more.

The comparison sample C having the same configuration of the samples E1 to E3 produced by the related-art manner was evaluated by the same manner described above.

In the evaluation, the number of the honeycomb structure bodies produced by using each sample was counted until the useful life of each die was given out.

FIG. 16 shows the evaluation result of the samples E1 to E3 and the comparison sample C in useful life (or durability) as a fourth embodiment of the present invention.

As shown in FIG. 16, the sample E1 of the die 1 produced by the method of the first embodiment using the CVD process has the improved productivity of the honeycomb structure bodies which is three times of that of the sample C which was produced without any CVD process.

The sample E2 of the die 1 produced by the method of the second embodiment using the PVD process has the improved productivity of the honeycomb structure bodies which is twice of that of the sample C which was produced without any CVD process.

The sample E3 of the die 1 produced by the method of the third embodiment using the combination of the CVD process, the PVD process, and the hardening process has the improved productivity of the honeycomb structure bodies which is three times of that of the sample C produced without the CVD and PVD processes.

Accordingly, it can be understood that the dies produced by the methods according to the first to third embodiments of the present invention has superior durability and superior abrasion proof performance and has an increased useful life.

The method of producing the dies according to the present invention described above uses alloy tool steel (SKD) as the die member. It is possible to use, as the die member, one of metals such as SKH (high speed steel), Stainless, Aluminum alloy, Titanium, Inconel®, HASTELLOY®, Stellite, Cemented carbide alloy, cermet, and related materials, instead of SKD. The use of such a metal can easily and certainly form the hardening treated film on the die member.

Further, the method of producing the dies according to the present invention described above uses CVD, PVD or a combination of CVD and PVD in the hardening process. It is possible to perform the hardening process by using one of DLC, electroplating and electroless plating. Such manners can form the hardening treated film with high accuracy, and it is possible to certainly enhance the durability and abrasion proof performance of the die produced by performing such manners. It is possible to use another manner and further possible to combine a plurality of those manners.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A method of producing dies for performing extrusion molding of honeycomb structure bodies, each die having batch supply holes and slit grooves formed in a lattice shape joined to the batch supply holes, and the slit grooves being capable of shaping the ceramic batch to a honeycomb structure body of a honeycomb shape, the method comprising steps of:
preparing a die member;
hardening at least a slit groove formation surface of the die member in order to form a hardening treated film on the slit groove formation surface, where a hardness of the hardening treated film is not less than 1.5 times of the hardness of the die member; and
forming slit grooved in the slit groove formation surface of the die member.

2. The method according to claim 1, wherein the hardening process is performed by one of PVD, CVD, DLC, electroplating, and electroless plating.

3. The method according to claim 1, wherein the method uses the die member whose hardness is not less than Hv 500.

4. The method according to claim 1, wherein the method uses the die member whose hardness is within a range of Hv 500 to 760.

5. The method according to claim 1, wherein the hardening process forms the hardening treated film whose hardness is not less than Hv 750.

6. The method according to claim 1, wherein the hardening process forms the hardening treated film whose hardness is not less than Hv 1500.

7. The method according to claim 1, wherein the hardening process forms the hardening treated film whose thickness is not more than 1/10 times of a depth of each slit groove.

8. The method according to claim 1, wherein the hardening process forms the hardening treated film whose thickness is not more than 0.5 mm.

9. The method according to claim 1, wherein the die member is made of one of SKH (high speed steel), SKD (alloy tool steel), Stainless, Aluminum alloy, Titanium, Inconel®, HASTELLOY®, Stellite, and Cemented carbide alloy, cermet.

10. The method according to claim 2, wherein the die member is made of one of SKH (high speed steel), SKD (alloy tool steel), Stainless, Aluminum alloy, Titanium, Inconel®, HASTELLOY®, Stellite, and Cemented carbide alloy, cermet.

11. The method according to claim 9, wherein the method uses the die member whose hardness is not less than Hv 500.

12. The method according to claim 9, wherein the method uses the die member whose hardness is within a range of Hv 500 to 760.

13. The method according to claim 9, wherein the hardening process forms the hardening treated film whose hardness is not less than Hv 750.

14. The method according to claim 9, wherein the hardening process forms the hardening treated film whose hardness is not less than Hv 1500.

15. The method according to claim 9, wherein the hardening process forms the hardening treated film whose thickness is not more than 1/10 times of a depth of each slit groove.

16. The method according to claim 9, wherein the hardening process forms the hardening treated film whose thickness is not more than 0.5 mm.
